(19) United States
(12) Patent Application Publication
(10) Pub. No.: US 2010/0302233 A1
(43) Pub. Date: Dec. 2, 2010

(54) Virtual Diving System and Method

(76) Inventor: David Ames HOLLAND, Annandale, VA (US)

Correspondence Address: JAMES W. PRAVEL;PRAVEL INTELLECTUAL PROPERTY LAW, PC, 1800 DIAGONAL ROAD, SUITE 600, ALEXANDRIA, VA, 22314, US

(21) Appl. No.: 12/471,580

(22) Filed: May 26, 2009

(51) Int. Cl. G06T 17/00; G06F 17/30; G09G 5/00; G06F 3/03; G06N 5/02

(52) U.S. Cl. 345/419; 345/8; 345/156; 345/584; 706/46; 715/810; 707/E17.019; 707/E17.018; 707/E17.016; 345/549

(57) ABSTRACT

An underwater diving simulation system includes at least three surface electronics units defining a diving area in proximity to a desired dive location. Each surface electronics unit includes a microprocessor-controlled transceiver that receives x-y-z position data from an underwater acoustical transponder located on a diver who is located in the diving area. The system provides user selectable, variable underwater virtual reality data to the diver via a communication link. A plurality of sensors in proximity to the diver's head transmits real-time rate of change, horizontal and vertical position of the diver's head to a signal decoder located on at least one of the surface electronics units via said communication link. A pair of projectors and optical elements are typically provided, one for each of the diver's eyes on a diving mask. The virtual reality images are generated by a graphics-processing unit in real-time response to the position and orientation of the diver and the diver's head whereby the diver can experience a virtual reality of diving in a user selectable location and with user selectable sea creatures.

### CROSS REFERENCE TO RELATED APPLICATIONS

Not applicable.

### STATEMENT REGARDING FEDERALLY SPONSORED RESEARCH OR DEVELOPMENT

Not applicable.

### REFERENCE TO MICROFICHE APPENDIX

Not applicable.

### BACKGROUND OF THE INVENTION

1. Field of the Invention

The present invention relates to the field of virtual reality devices. In particular, the invention relates to a system and method to simulate underwater diving in a variety of desired environments.

2. Description of the Related Art

In an era of increasing fuel prices and dwindling natural resources, one constant continues to be many people's desire to travel to exotic locations and experience relaxing recreation. One such form of recreation is scuba diving on the world's coral reefs, shipwrecks, and other sites. Unfortunately, the cost of such travel has traditionally made such experiences prohibitive for the majority of people. This motivates the question of whether such an experience could be provided in bodies of water closer to where people live.

Over the years, there have been numerous patents issued in the area of virtual reality. These patents fall roughly into two categories: those that enhance the state of the art with regard to the basic science required to achieve a lightweight head-mounted display, or mask and those that relate to the application of virtual reality. Within the applications category, there are several distinct areas of interest that include general recreation/fitness, medical/therapeutic applications, entertainment, and database usability.

U.S. Pat. No. 4,884,219 to Waldren relates to a head-mounted virtual reality device. It discloses moving a pair of viewing screens from a roll-around type platform into a mask mounted and worn on the user's head. U.S. Pat. No. 5,151,722 to Massof et al. shows an optics arrangement whereby the image source is mounted on the side of the user's head, and the image is reflected off of a series of mirrors.

Patents have also issued that relate to entertainment and recreation. For example, U.S. Pat. No. 5,890,995 to Bobick et al. and German Patent 3706250 to Reiner disclose systems that couple a virtual reality mask with pedaled exercise equipment. The user mounts a bicycle and can navigate through virtual environments that represent either a synthetic playing field with avatars (computer-graphics generated “opponents”) or a synthetic road with vehicles and other bicyclists.

U.S. Pat. No. 6,428,449 to Apseloff addresses individuals who choose to run on a treadmill, rather than pedal a bicycle, while watching the screen. The system is responsive to both body motion and verbal cues. The invention is sensitive to the particular aspects of the running activity, such as providing for a means to detect the pace of the runner's cadence.

US Patent Publication 2002/0183961 to French et al. focuses on the artificial intelligence algorithms for rendering opponents in a virtual environment (such as a tennis player who anticipates the user's next move or tries to put the user on the defensive) and is intended to serve as an invention for the purpose of training. The system senses the player's 3D position in real-time and renders the avatars' responses accordingly. Unlike the three previous patents, this invention does not address the interface between the computer system and more traditional mechanical training equipment such as treadmills and stationary bikes.

US Patent Publication 2004/0086838 to Dinis shows a scuba diving simulator including an interactive submersible diver apparatus and a source of selectable underwater three-dimensional virtual images. The system disclosed requires the user to hold his or her head pressed to a viewer with a view port. There is no change in scenery when the user changes the position of his or her head relative to the underwater environment. Also, inputs to the Dinis system originate from joysticks and rods that the diver holds onto, and constant supervision from an operator is required. Further, the diver in Dinis is restricted by the position of the connecting cable to the surface at a fixed location. Further still, the images provided in Dinis are static and not dynamic.

US Patent Publication 2007/0064311 to Park discloses a head mounted waterproof display.

US Patent Publication 2008/0218332 to Lyons shows a monitoring device to alert a swimmer that he or she is approaching a boundary or wall.

Nintendo® markets underwater simulation software under the trademark Wii® known as Endless Ocean™. The software includes fictional scenes only and requires that you control an avatar (solo diver) onscreen by using a joystick or a remote control device.

What is needed is a system and method that addresses the need for a low-cost, scuba diving recreation option without the expense or inconvenience associated with physical travel to distant diving locations. The system and method should include the ability to allow the user to experience scenery in real time, based upon the position of his or her head relative to a mobile, triangulation positioning and navigation system.

### BRIEF SUMMARY OF THE INVENTION

An underwater diving simulation system comprises at least three surface electronics units that define a diving area. The surface electronics units are positioned in proximity to a desired dive location. Each surface electronics unit includes a microprocessor-controlled transceiver that receives x-y-z position data from an underwater acoustical transponder located on a diver who is located in the diving area. At least one of the surface electronics units includes a graphic processing unit that provides user selectable, variable underwater virtual reality data to the diver via a communication link. A plurality of sensors in proximity to the diver's head is provided to transmit the real-time rate of change, horizontal and vertical position of the diver's head to a signal decoder via the communication link. The plurality of sensors located in proximity to the diver's head is typically attached or integral with an underwater diving mask that is worn by the diver. The mask has at least one optical element visible by the diver. Typically a pair of projectors is provided, one for each of the diver's eyes. Each projector sends video to the at least one optical element, which displays underwater virtual reality images to the diver while the diver swims within the dive area. The virtual reality images are generated by the graphics-processing unit in real-time response to the position and orientation of the diver and the diver's head whereby the diver can experience a virtual reality of diving in a user selectable location and with user selectable sea creatures.

### BRIEF DESCRIPTION OF THE DRAWINGS

FIG. 1 is a perspective illustration showing the inventive apparatus being used underwater by a diver.

FIG. 2 is a perspective view of the inventive mask.

FIG. 3 is a front view of the control console.

FIG. 4 is a side view of the inventive mask shown in FIG. 2.

FIG. 5 is a partial isometric view of a transponder, Doppler velocity sensor (“DVS”) and DVS transducer, all secured to a SCUBA tank.

FIG. 6 is a flow-schematic showing inventive system elements and a method of operation.

### DETAILED DESCRIPTION OF THE INVENTION

The invention comprises a system of software, sensors, and hardware components that can be partitioned into two groups. The first group of elements includes surface electronics, which are housed in surface electronics units and are responsible for the production of an immersive underwater virtual reality that responds to real-time environmental inputs. The second group of elements includes a diving mask with electronics and sensors that is worn by a diver D and is responsible for delivering a virtual reality (“VR”) experience to the diver, as well as for providing a set of sensor readings that are used to update the VR experience. Together, the two groups comprise a feedback loop of information that renders a real-time, interactive underwater virtual world that anyone can experience without having to travel to a tropical or a remote location.

The following table lists the physical and process elements of a preferred embodiment of the inventive system:

| Element | |
|---|---|
| Number | Element |
| M | Mask |
| B | Primary Buoy |
| B1, B2 | Secondary Buoys |
| C | Control Console |
| T | Tether |
| T1, T2 | Secondary Tethers |
| 2 | Underwater Terrain Database |
| 3 | Loop Initialization State |
| 4 | Done State - User Has Exited System |
| 5 | 3D Sea Creatures Database (geometry) |
| 6 | Artificial Intelligence (“AI”) Module |
| 7 | 3D World Transformer |
| 8 | Scene Graph Database |
| 9 | Graphics Processing Unit (“GPU”) |
| 10 | Level of Detail Culling |
| 11 | Atmospherics Processor |
| 12 | 3D Sea Creatures Database (scripts) |
| 13 | Transponder |
| 13a | Depth Sensor |
| 13b | Transducer |
| 14 | Formatting Circuitry/Mask Encoder |
| 15 | Projection and Scan-Line Conversion Module |
| 16-1, | Transceivers |
| 16-2, | |
| 16-3 | |
| 17-1, | Picture Formatters |
| 17-2 | |
| 18 | Frame Buffer |
| 19 | Mask Video Decoder |
| 20 | Texture-Mapping Library |
| 23 | Buoy Video Encoder |
| 25 | 3D Game Engine (“game engine”) |
| 25a | Secondary Circuit Card |
| 26-1, | Optics Projectors |
| 26-2 | |
| 27 | Embedded Optical Elements |
| 28 | Doppler Velocity Sensor (DVS) |
| 28a | DVS Enclosure |
| 28b | DVS Transducer |
| 29 | Mask Sensor Card |
| 29a | Accelerometer |
| 30-1 | Tilt Sensor (inclinometer) |
| 30-2 | Compass |
| 31 | Navigation Unit |
| 32 | Signaling Circuit |
| 34 | Signal Decoder |
| 35 | Software Camera |
| 36a | Decision State: Has User Exited? |
| 36b | Increment Time Step |
| 37 | On/Off Switch |
| 38 | SCUBA Tank |
| 40 | Mask Picture Formatter and Signaling Circuit Card |
| 50 | DVS Cable |
| 52 | Dive Flag |
| 52a | Dive Flag Pole |
| 53 | Panel |
| 54 | Toggle |
| 54a | Select Button |
| 60a | Mask Components |
| 60b | Diver Components |
| 62 | Mask Optics and Sensors |

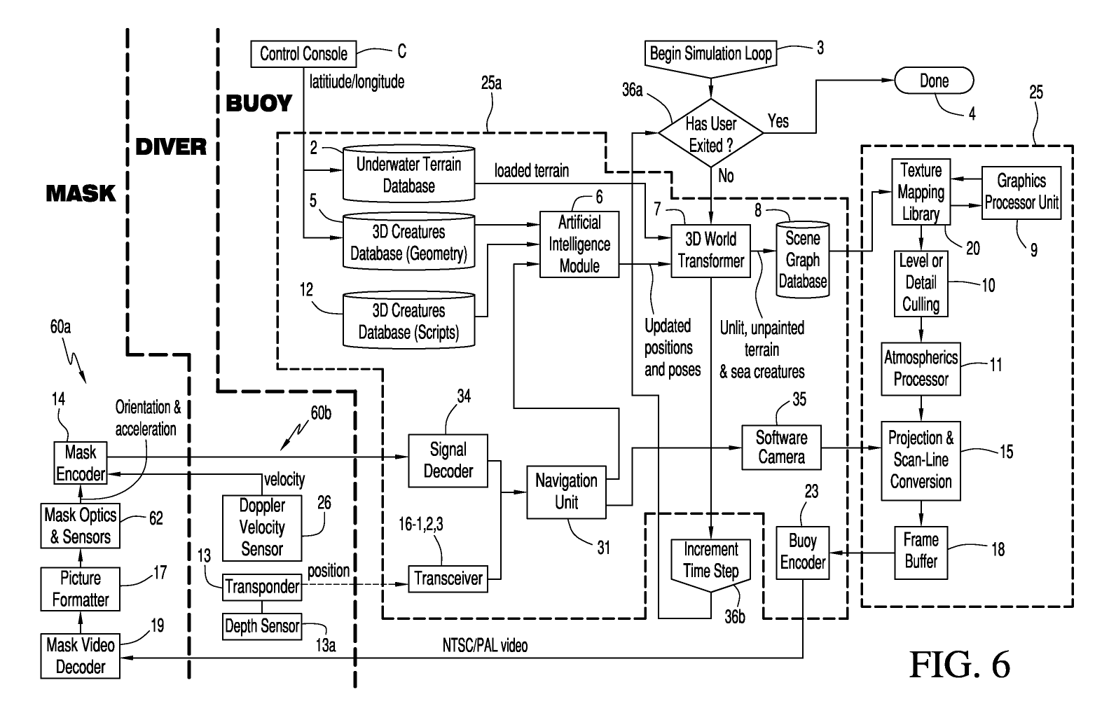

FIG. 6 shows a flow-schematic of the inventive system. The system includes a control console C, a secondary circuit card 25a, a 3D game engine 25, mask M components 60a, Diver components 60b and logic flow elements.

Information flows, with respect to the flow-schematic (FIG. 6), in a generally clockwise manner. The following description of the flow of information through the system corresponds to an approximate, clockwise path through the flow diagram, starting in the upper left-hand corner.

The first group includes surface electronics contained in a buoy B that floats near the diving site and has the computing power roughly equivalent to that of a laptop personal computer.

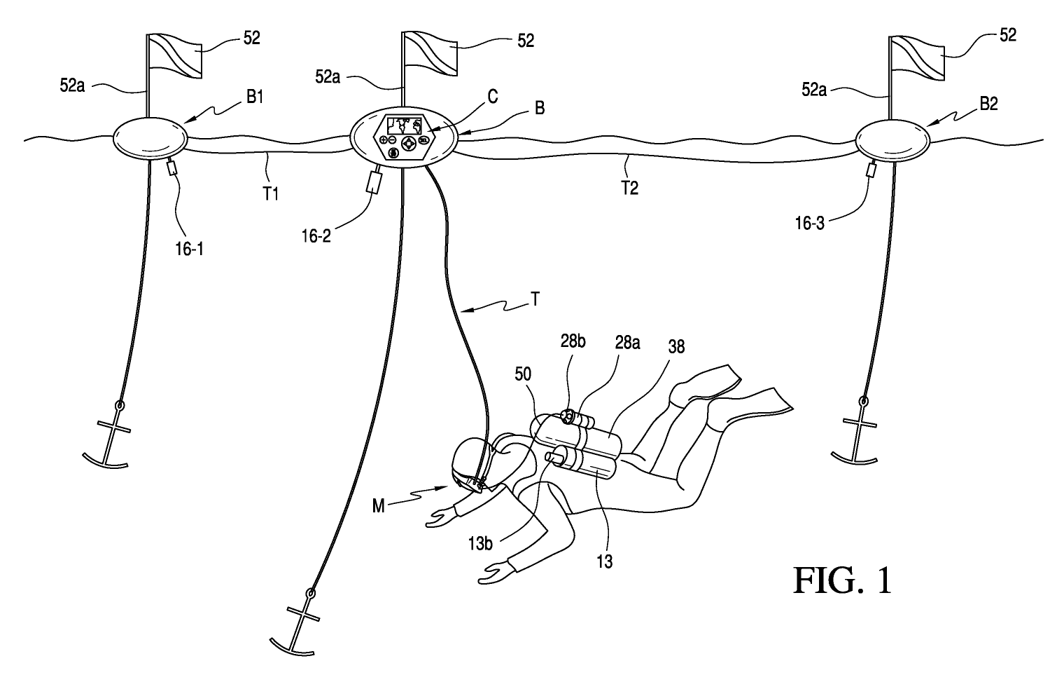

A view of the overall system is shown in FIG. 1. Buoys B, B1 and B2 each include a transceiver 16-2, 16-1 and 16-3, respectively. Buoys B1, B2 are connected to buoy B with a communication cable T1, T2, respectively. Each buoy B, B1, B2 may be anchored to the bottom of a lake, swimming pool, or other area where the person is diving. A plastic pole 52a is typically attached to the top of each buoy B, B1, B2 with a highly visible flag 52 to indicate to boaters that diving activity is taking place. In one embodiment, this may be the standard PADI/NAUI diving flag 52 that indicates diving in the vicinity. The buoys B, B1, B2 are designed to float upright so that the upper volume remains above water and is accessible to the diver. On the front of the buoy B is a control console C, which is typically illuminated (see FIG. 3). When the diver first switches the control console C on with an on/off switch 37, a panel 53 illuminates to offer program options, in a manner similar to exercise equipment that can be found in gyms and recreation centers. It is contemplated that instead of buoys, B, B1, B2, shore based units may be used to house the surface electronics from which the transceivers 16-1, 16-2, 16-3 may be deployed.

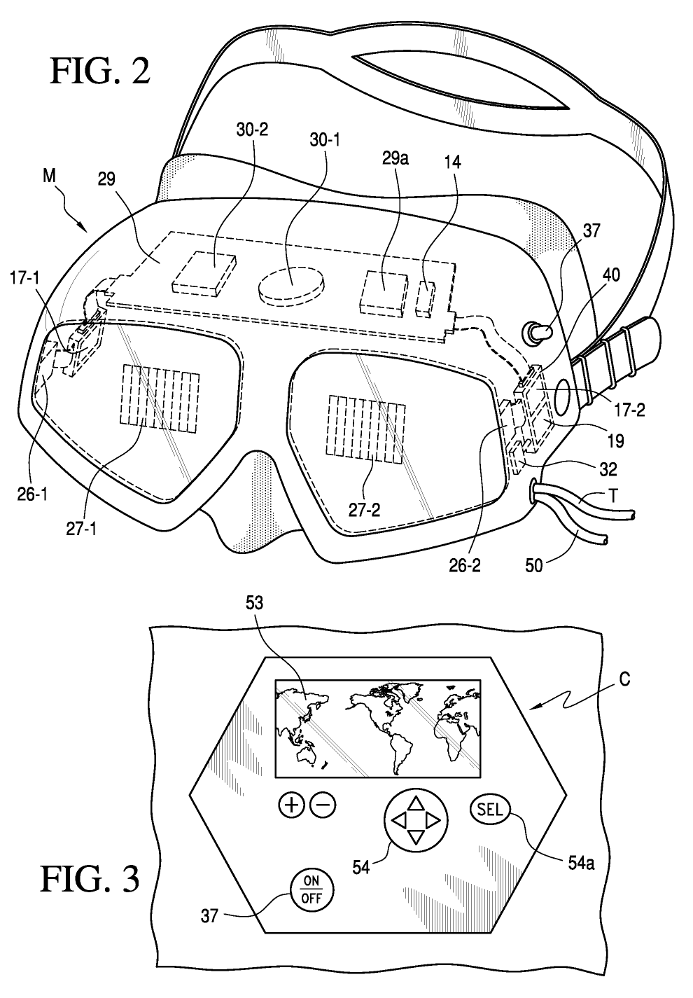

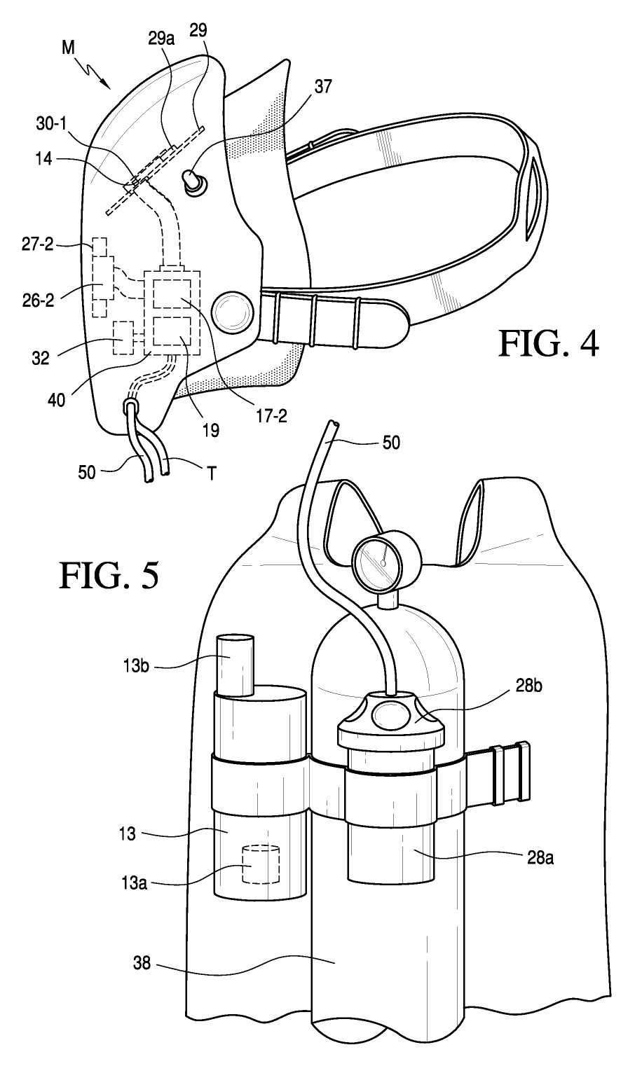

Once the region has been selected with the toggle 54, as confirmed on the display 53 with the select button 54a, the diver D, (or an assistant) may then choose the type of dive. In one embodiment, the type of dive may be one of several generic diving scenarios, such as coral reef or shipwreck. Alternately, the diver D may choose between one of several specific diving sites, such as a national underwater park or a nature preserve site. It is contemplated that a site may also be selected from a geophysical mapping source, such as Google® Earth. Once these selections have been made, a simple circuitry card in the console C announces the activation of the program to the 3D game engine 25, the secondary circuit card 25a, and the mask video decoder 19 in the mask M. The mask M (shown in FIGS. 2 and 4), on the left side includes a picture formatter 17-1 and an optics projector 26-1. On the right side, the mask M includes a mask video decoder 19, a picture formatter 17-2 and a signaling circuit 32. The mask video decoder 19 and picture formatter 17-2 are both mounted on a card 40. After choosing the diving program (location and dive type) the control console C interface sends the latitude and longitude of the chosen site (or some other unique identifier) to the underwater terrain database 2, the 3D creatures database (geometry) 5 and the 3D creatures database (scripts) 12.

First, the program populates a scene graph database 8 with data from an underwater terrain database 2 and wireframe mesh geometry (i.e. faces, edges and vertices) of the sea creatures from the 3D sea creatures database (geometry) 5. The database structure used may be similar to those used in Apple iPhone™ or similar to a more industrial strength product such as SQL Server 2005. The raw computing power of the graphics pipeline resides in hardware Graphics Processing Unit (“GPU”) 9. The GPU 9 serves as high-speed cache, or buffer, for storing data such as the pixels that comprise the texture of an object or the geometry (vertices, edges, and faces) that comprise a mesh, or wireframe representation of a real-world creature. The GPU 9 is a dedicated, rapid-access memory with mathematic routines for performing matrix algebra and floating point operations. The textures for each sea creature and terrain are loaded from the databases 2, 5, 12 and stored in the GPU 9 prior to execution of the main simulation loop (shown in FIG. 6) so that they can be retrieved rapidly during loop execution.

Referring again to FIG. 6, the program instantiates and allocates memory for a software camera 35 for representing the view of the diver in the 3D world. The software camera 35 is a virtual camera that has attributes of both position and orientation (attitude with respect to a world coordinate system) and uses matrix transformations to map the pixels of the 3D world onto a plane. Graphics application program interfaces, such as Direct3D, contain the software tools for performing these rendering functions. At a minimum, the rendering functions include a mathematical representation of the projection plane (similar to the back plane of a pin-hole camera), the normal vector to this plane, and the position of the plane in 3D space.

The program selected by the user calls another function that loads behavior scripts from the 3D sea creatures database (scripts) 12 into an area of memory where they are available to the artificial intelligence (“AI”) module 6. Initial set-up of the creatures in the 3D sea creatures database 12 includes a script that adjusts their positioning, articulation, and their state assignment (floating, fleeing, swimming, etc). The scripts can be written using one of several commercially available or open-source software packages known under the trade marks Maya, 3D Studio, Blender, or Milk Shape 3D. The scripts prescribe the motion of the creatures in the coordinate system and are distinct from the code of the software itself. In a preferred embodiment, the scripting is updated in real-time according to stochastic artificial intelligence algorithms that introduce randomness into the creature behavior as a response to external stimuli, either from other virtual sea creatures in the environment or from the diver D or other user. For example, a school of fish may shrink back in response to the virtual presence of the diver D in their swim area, based upon the position vector of the diver D at a given point in time. Data flows from the navigation unit 31, which is located on the secondary circuit card 25a (see FIG. 6), to the AI module 6 to accomplish this. The navigation unit 31 is a software code that combines the sensor inputs from the signal decoder 34, and transceivers 16-1, 16-2 and 16-3. Once the new positions and poses have been determined, the 3D world transformer 7 makes adjustments to the scene graph database 8. The 3D world transformer 7 is a transformation algorithm that uses matrix algebra to make the adjustments to the scene graph database 8.

Finally, the real-time scene rendering engine simulation loop begins 3. A variable such as elapsed time is initialized and is used to keep track of time in the simulation. During the loop a test is done to see if the diver has exited 36a the simulation by turning an on/off switch 37 on the mask M to the “off” position. If the on/off switch 37 has not been turned to the off position, the time step 36b is incremented and the loop repeats.

Scene rendering may be implemented using a commercially-licensed game engine 25. The game engine 25 provides scene rendering by traversing the scene graph database 8 to operate on only the part of it that is actively in the diver's D view. As the diver D moves around, different areas of the scene graph database 8 are culled and drawn by the game engine 25. The objects in the scene (fish, coral, other landscape features) are attached as “nodes” to the scene graph 8, as a way of efficiently organizing the objects. Every node in the scene graph database 8 goes through additional processing. First, the game engine 25 computes key-frame poses of the creatures for the next frame. Next, world transformations (e.g., rotation, translation) are computed by the 3D world transformer 7 using a virtual world transformation algorithm and are applied to the scene graph database 8 based on velocity, acceleration, and position of the diver. Textures are obtained from the GPU 9 by a set of program texture mapping functions from a texture-mapping library 20 and painted onto the scene. Caustics (sea bottom refracted light patterns) are applied with the atmospherics processor II to the ocean floor/terrain mesh and to coral, sunken ship, large creatures, etc. Waves above the diver D may also be simulated. Finally, the underwater objects are projected onto the camera viewing plane via a software projection and scan-line conversion module 15 to form the scene image for a given time stamp. This comprises one frame of the simulation.

Before being sent to the mask M, each frame is encoded by the buoy video encoder 23. The encoding may use a technique such as the Discrete Cosine Transform (“DCT”) to reduce the number of bits in the signal that need to be transmitted. One may guide the meaning of the encoding with a desired video standard such as MPEG-4. In a preferred mode of the invention, the buoy sends an encoded NTSC, PAL, or other digital video signal along a tether T directly to the mask video decoder 19 on the mask M (FIG. 2). In the handshake protocol, the signal decoder 34 on the buoy B waits to transmit the video frames until the mask encoder 14 notifies it that the diver D is ready to receive the signal. The buoy's B on-board game engine 25 also includes a frame buffer 18 to ensure that the images are sent to the LCDs that are contained on the embedded optical elements 27-1, 27-2 (FIG. 2) at regular intervals. After arriving at the mask video decoder 19 on the mask M, the signal is decoded into the RGB values for the LCD pixel map with the mask video decoder 19.

By this time, the diver D has donned the mask M (shown in FIGS. 2 and 4) and has switched on the receiver using the on/off switch 37. After pinging and discovering the GPU 25 in the buoy B, the mask M sensors (accelerometer 29a, inclinometer 30-1, compass 30-2) begin transmitting signals back to the buoy B via the tether T indicating the velocity, acceleration, and attitude of the diver's D head.

As previously indicated (See FIG. 6), there are two physically co-located sub-systems: the mask components 60a and the diver components 60b, the mask components 60a are located on or in the mask M and the diver components 60b are located on the back of the diver D.

The sensor system responsible for determining the position of the diver employs acoustic short baseline technology. A trio of transceivers 16-1, 16-2, 16-3 and a transponder 13 (FIGS. 1 and 5) provide the position of the diver in the x, y and z (depth) coordinate positions. A transducer 13b is interfaced with the transponder 13 to convert electrical energy and data from the transponder 13 into acoustical sound energy to communicate depth and position data to the surface transceivers 16-1, 16-2 and 16-3. A depth sensor 13a is internal to the transponder 13. In a preferred embodiment, the three transceivers 16-1, 16-2, 16-3 are mounted in at least three buoys, typically about 10 meters apart, and the transponder 13 is mounted in a backpack worn by the diver D, next to or attached to the SCUBA tank 38. Desert Star™ manufactures a Target-Locating Transponder (trademark “TLT-1”) that could be used for transponder 13. It is contemplated that all three transceivers 16-1, 16-2 and 16-3 could be mounted on a single buoy B, B1 or B2. It is also contemplated that the distance between buoys could vary as desired. The purpose of buoys B1 and B2 is to provide a more precise position triangulation. The accuracy of the triangulation increases as the distance apart of the transceivers 16-1, 16-2 and 16-3 increases. It is contemplated that more than three transceivers could be used and that the transceivers could be suspended from fixed, non-floating structures or from floating structures other than buoys. An alarm system may also be used to alert the diver D if he or she travels outside of the dive area defined by the transceivers 16-1, 16-2 and 16-3.

As the diver D moves about in the water in the dive area defined by the buoys B, B1 and B2, a Doppler Velocity Sensor (“DVS”) 28 mounted in an enclosure 28a on the diver's D back transmits his or her body's velocity vector. A DVS 28 includes a piston or phased array transducer 28b attached to an electronics enclosure 28a, which houses the DVS 28. The electronics enclosure 28a for the DVS 28 is also carried on the diver's D back, housed next to the transponder 13. The DVS 28 transmits data to the signal decoder 34 via DVS cable 50, which is connected to the tether T. Examples of suitable DVS 28 include DVS units manufactured under the trademarks Explorer Doppler Velocity Log (DVL) or NavQuest 600 Micro DVL by LinkQuest, Inc. The DVS electronics module enclosure 28a is approximately the same size as the transponder 13 and weighs about 1.0 kg in water. The piston or phased array transducer 28b that actually takes the velocity reading typically weighs about 0.85 kilograms and could be mounted on the backpack. The velocity data is transferred to the mask encoder 14 and then to the signal decoder 34.

In contrast to the equipment on the diver's D back, the sensors mounted on the mask, as shown in FIGS. 2 and 4, typically weigh less than a kilogram. A tri-axial accelerometer 29a, for example such as the type used in video game controllers such as the Apple® iPhone™, measures the acceleration vector of the diver's D head. A combination of a dual-axis electrolytic tilt sensor inclinometer 30-1 and compass 30-2 provide the orientation of the mask M and diver's D head with respect to the reference coordinate system that resides in the GPU 9. The orientation is essentially determined from the accelerometer 29a, the inclinometer 30-1 and the compass 30-2 by the Earth's gravitational and magnetic fields. The three mask sensor components (i.e. the accelerometer 29a, the inclinometer 30-1 and the compass 30-2) taken together are small relative to the positioning and velocity components (i.e. the transponder 13, the DVS enclosure 28a/DVS 28, and DVS transducer 28b). Overall, the mask sensor components are housed in chips (29a, 30-1 and 30-2) less than 2.5 cm square. They reside on a mask sensor card 29 that is positioned in the top of the mask M. Also included on the mask sensor card 29 is a formatting circuitry/mask encoder 14 that provides for formatting a signal sent back to the buoy B via the tether T. The tether T is typically a twisted pair of conductive signal cables that are surrounded by a submersible protective sheath. It is contemplated that a wireless communication link between the sensors on the mask and the surface electronics could be provided with a wireless underwater acoustic data link.

The mask sensor components' purpose is to provide an accurate location for the diver so the software resident in the GPU 9 on-board the buoy B can render the virtual world. A software module written in C/C++ or assembly contained in the navigation unit 31 combines the decoded velocity, acceleration, and compass, and tilt readings to provide a finer level of detail so that sudden changes in motion are accurately rendered.

The signals from the mask sensor components pass through the formatting circuitry/mask encoder 14 and are then sent along the tether T to a signal decoder 34 and the navigation unit 31 on-board the secondary circuit card 25a in the buoy B. Simultaneously, the signal and x-y-z position data from the transponder 13 and depth sensor 13a on the diver's D back are received by the transceivers 16-1, 16-2, 16-3 on the buoys B. The diver's D x-y-z position data is then passed to the navigation unit 31. The navigation unit 31 combines the sensor readings and computes the real-time position/orientation estimation before passing the vectors to the software camera 35. Position, velocity, acceleration, and orientation data are processed as events using dead-reckoning algorithms to derive, for each frame of the simulation, an instantaneous estimation of the diver's D head position and orientation. Velocity and acceleration vectors serve as inputs to converge the estimated position and orientation vectors of the diver's D head, as represented by the software camera 35. A multi-threaded (parallel) algorithm may also be implemented to combine the sensor readings to obtain an estimation of the diver's D head position and orientation.

After the mask M sensor components 29a, 30-1, 30-2 have begun transmission of attitude and position via the tether T, a signaling circuit 32 in the mask M begins to ping the transceivers 16-1, 16-2, 16-3 via the tether T to locate the video signal from the GPU 9. Upon a successful handshake, the video signal is received by the mask decoder 19 on the mask M. Circuitry, comprising a picture formatter 17-1, 17-2, on-board each side of the mask, generates and formats a picture from the video signal as it comes in and pushes the picture to the optics projectors 26-1, 26-2 on each side of the mask M. The optics projectors 26-1, 26-2 send the video to the optical elements 27-1, 27-2, which are embedded on each side of the mask M transparent viewing surface, one for each eye.

Alternative optics for the mask M currently exist. Lumus Optical Corporation of Israel has developed one such component. The Lumus component comprises a so-called Light Optical Element (“LOE”) and a “Micro-Display Pod.” The LOE may be substituted in the instant invention for the optical elements 27-1, 27-2. The LOE comprises a refracting ultra-thin lens that displays a high resolution and full color images in front of the eye. It does this through the use of a series of refracting glass planes, tilted at varying angles to direct the image onto the retina as if it originated at a distance from the viewer. The second component, the display “pod,” is essentially a pair of projectors embedded in the sides of the eyeglasses that receive the image content and project it into the LOE.

After the simulation has began and the mask sensor components have begun communicating with the GPU 9 as previously described, the diver D can float or swim through the water and interact with the various sea creatures that inhabit the virtual environment. He or she may dive through a shipwreck for example or choose to inspect some unusual-looking coral. He or she may pass through a school of virtual fish or choose to pet a manta ray, all without having left the lake, beach, or swimming pool where the inventive system has been set up.

If the diver D needs to exit the simulation, he or she can move the on/off switch 37 on the side of the mask (M) to the “off” position. The simulation terminates when the on/off switch 37 is turned to “off” and the GPU 25 enters a ‘done’ state. After 2 minutes, the system shuts off completely to conserve battery power.

The invention is not limited to the above-described embodiments and methods and other embodiments and methods may fall within the scope of the invention, the claims of which follow.

What is claimed is:

1. An underwater 3D virtual reality system comprising:
a. at least three surface electronics units that define a diving area; said surface electronics units being positioned in proximity to a desired dive location; each surface electronics unit includes a microprocessor-controlled transceiver that receives x-y-z position data of a diver from an underwater acoustical transponder located on a diver who is located in said diving area;
b. at least one of said surface electronics units includes a graphics processing unit that provides user selectable, variable underwater virtual reality data to the diver via a communication link; and
c. a diving mask worn by the diver having at least one optical element visible by the diver; said at least one optical element displays underwater virtual reality images from said graphics processing unit to said at least one optical unit while the diver swims within said dive area whereby the diver can experience the virtual reality of diving in a user selectable location and with user selectable sea creatures.

2. An underwater virtual reality system according to claim 1 wherein a plurality of sensors in proximity to the diver's head transmit the real-time rate of change, horizontal and vertical position of the diver's head to a signal decoder on at least one of said surface electronics units via said communication link and said virtual reality images are generated by said graphics processing unit in real-time response to the position and orientation of the diver and the diver's head.

3. An underwater virtual reality system according to claim 2 wherein said plurality of sensors in proximity to the diver is located on said diving mask.

4. An underwater virtual reality system according to claim 1 wherein a pair of said optical elements is provided, each said optical element visible and in proximity to each of the diver's eyes.

5. An underwater virtual reality system according to claim 1 wherein a control console is provided on at least one of said surface electronics units, said control console being operatively connected to electronic circuits on said at least one surface electronics unit;
a. Said control console includes user selectable options from said electronic circuits containing an underwater terrain database and a 3D creatures database;
b. Said electronic circuits include a scene graph database and an artificial intelligence module to which user selectable data is passed for processing by a 3D game engine.

6. An underwater virtual reality system according to claim 5 wherein user selectable options from said control panel includes the type of dive selected from the group consisting essentially of a coral reef or a shipwreck, said type of dive corresponding to data included in said underwater terrain database and said 3D creatures database.

7. An underwater virtual reality system according to claim 5 wherein user selectable options from said control panel includes the specific location of the dive site, wherein said dive site corresponds to data in said underwater terrain database and said 3D creatures database.

8. An underwater virtual reality system according to claim 7 wherein said specific locations is selected from the group consisting essentially of national underwater parks and marine preserves, wherein said specific locations correspond to data in said underwater terrain database and said 3D creatures database.

9. An underwater virtual reality system according to claim 5 wherein said electronic circuits includes a script that includes the 3D creatures positioning, articulation and their state assignment, wherein said state assignment is selected from the group consisting essentially of floating, fleeing or swimming.

10. An underwater virtual reality system according to claim 9 wherein said state assignment is assigned in response to the presence of virtual sea creatures in the underwater environment.

11. An underwater virtual reality system according to claim 9 wherein said state assignment is assigned based on said x-y-z position of the diver as processed by an artificial intelligence module and a 3D world transformer, said artificial intelligence module and said 3D world transformer included in said electronic circuits.

12. An underwater virtual reality system according to claim 1 wherein said underwater virtual reality data is contained on a scene graph having a data structure on said 3D game engine; said underwater virtual reality data are attached as nodes to said scene graph; a world transformer applies world transformations to said underwater virtual reality data based on the velocity, acceleration and position of the diver and passes said transformations to said scene graph, a texture is provided to said underwater virtual reality data and passed to said scene graph with texture mapping functions from a texture mapping library, an atmospherics processor is provided to apply caustics to said underwater virtual reality data, and a scan-line conversion module provides a projection of underwater objects to the underwater virtual reality data with a software projection whereby a scene frame is formed for a given time stamp in said scene graph.

13. An underwater virtual reality system according to claim 12 wherein a buoy video encoder encodes each said scene frame and transfers said scene frame to a mask encoder on a diving mask on the diver via said communication link.

14. An underwater virtual reality system according to claim 13 wherein a frame buffer is provided to buffer said scene frame during the transfer of said scene frame to a decoder on the diving mask and wherein images from said scene frame are decoded into RGB values and transferred to at least one optical element viewable by the diver.

15. An underwater virtual reality system according to claim 1 wherein said communication link is selected from the group consisting of a wired connection and a wireless connection.

16. An underwater virtual reality system according to claim 1 wherein a Doppler Velocity Sensor is provided in proximity to the diver to provide acoustical data, which identifies the diver's underwater velocity, to a signal decoder on at least one of said surface electronics units.

17. An underwater virtual reality system according to claim 1 wherein a tri-axial accelerometer, a dual-axis electrolytic tilt sensor inclinometer, and a compass, each located in proximity to a diving mask on the diver, provide said real-time rate of change, horizontal and vertical position of the diver's head to a signal decoder on at least one of said surface electronics units.

18. A method of simulating a virtual reality of scuba diving in a desired environment comprising the steps of:
a. defining a diving area with at least three surface electronics units;
b. positioning said surface electronics units in proximity to a desired dive location;
c. including a microprocessor-controlled transceiver in each said surface electronic unit;
d. receiving x-y-z position data by each said transceiver from an underwater acoustical transponder located on a diver who is located in said diving area;
e. providing variable underwater virtual reality data to the diver via a communications link with a graphics processing unit in at least one of said surface electronics units; and
f. displaying underwater virtual reality images from said graphics processing unit to at least one optical element in a diving mask visible by the diver while the diver swims within said dive area.

19. A method of simulating a virtual reality of scuba diving in a desired environment as claimed in claim 18 comprising the additional steps of:
g. transmitting the real-time rate of change, horizontal and vertical position of the diver's head from a plurality of sensors in proximity to the diver's head to a signal decoder on at least one of said surface electronics units via said communication link; and
h. generating said virtual reality images by said graphics processing unit in real-time response to the position and orientation of the diver and the diver's head whereby the diver can experience the virtual reality of diving in a user selectable location and with user selectable sea creatures.

20. A method of simulating a virtual reality of scuba diving in a desired environment as claimed in claim 19 comprising the additional steps of:
i. passing signals from said plurality of sensors through a formatting circuitry/mask encoder to a surface signal decoder;
j. receiving signal data from said transponder on the diver by said transceivers and passing said signal data to a navigation unit;
k. combining said signals from said plurality of sensors by said navigation unit;
l. computing the real-time position/orientation estimation of the diver and the diver's head and passing the resulting vectors to a software camera;
m. using dead-reckoning algorithms to derive from position, velocity, acceleration and orientation data, the estimated position and orientation vectors of the diver's head, as represented by said software camera;
n. pinging said transceivers by a signaling circuit in the mask to locate a video signal from the graphics processing unit;
o. generating and formatting a picture from said video signal with at least one picture formatter and pushing said video signal to said at least one said projector viewable by the diver;
p. sending said video signals to at least one optical element viewable by the diver; and
q. continuing steps a-p until the diver ends the dive by selecting an off position on a user selectable on/off switch.
